(19) United States
(12) Patent Application Publication
(10) Pub. No.: US 2026/0247051 A1
(43) Pub. Date: Aug. 20, 2026

(54) ARITHMETIC UNIT

(71) Applicant: Sony Semiconductor Solutions Corporation, Kanagawa (JP)

(72) Inventors: Masaki Sakakibara, Kanagawa (JP); Katsuhiko Hanzawa, Kanagawa (JP); Hideki Naganuma, Kanagawa (JP); Daisuke Saito, Kanagawa (JP)

(21) Appl. No.: 19/161,108

(22) PCT Filed: Mar. 24, 2023
(86) PCT No.: PCT/JP2023/012024

§ 371 Date: Aug. 29, 2025

(51) Int. Cl. H04N 25/772; H04N 25/709; H04N 25/771

(52) U.S. Cl. CPC H04N 25/772; H04N 25/709; H04N 25/771

(57) ABSTRACT

An arithmetic unit with suppressed power consumption is disclosed. In one example, an arithmetic unit includes a signal detector that outputs a first analog signal indicating a detection result of a physical signal, an AD converter provided at a subsequent stage of the signal detector, and a calculator that calculates a digital signal output from the AD converter and outputs a second analog signal indicating a calculation result. The signal detector has a floating diffusion layer that converts a physical signal into a first analog signal. The second analog signal is input to a preceding stage of the AD converter electrically connected to the floating diffusion layer.

### TECHNICAL FIELD

The present disclosure relates to an arithmetic unit.

### BACKGROUND ART

In recent years, to achieve advanced tasks such as image recognition and object position detection, a processor that has a deep neural network (DNN) implemented on hardware and performs calculation has been put into practical use. As a DNN calculation method, computing in memory (CIM) of performing calculation on a memory array unit which is a non-von Neumann type calculator has attracted attention.

### CITATION LIST

### Patent Document

Patent Document 1: Japanese Patent Application Laid-Open No. 2020-113809

### SUMMARY OF THE INVENTION

### Problems to be Solved by the Invention

Power consumption of a general neural network is dominated by access power due to massive memory access. This access power increases as the data transmission path becomes longer.

The present disclosure provides an arithmetic unit capable of suppressing power consumption.

### Solutions to Problems

An arithmetic unit according to an embodiment of the present disclosure includes a signal detector that outputs a first analog signal indicating a detection result of a physical signal, an AD converter provided at a subsequent stage of the signal detector, and a calculator that calculates a digital signal output from the AD converter and outputs a second analog signal indicating a calculation result. The signal detector has a floating diffusion layer that converts a physical signal into a first analog signal. The second analog signal is input to a preceding stage of the AD converter electrically connected to the floating diffusion layer.

The arithmetic unit may further include a signal input selection unit that selects the first analog signal or the second analog signal as an input signal to the AD converter.

The arithmetic unit may further include
a plurality of storage units that stores the digital signal between the AD converter and the calculator, and
a signal storage selection unit that selects a storage destination of the digital signal from the plurality of storage units.

The arithmetic unit may further include a plurality of pixel arrays in which pixels including the signal detector and the AD converter are arranged in a two-dimensional array.

The shape of the pixel array may be a square.

The shape of the pixel array may be a rectangle.

A plurality of the signal detectors may simultaneously detect the physical signal.

An AD converter of a pixel provided in a pixel array as a detection target of the digital signal among the plurality of pixel arrays may perform AD conversion on the first analog signal or the second analog signal.

After AD converters of a plurality of pixel arrays output the digital signal, the digital signal of a specific pixel array may be input to the calculator.

The calculator may include a capacitive element for performing product-sum operation on the digital signal.

A weighting factor of the product-sum operation may be set in the capacitive element on the basis of a power ratio of 2.

A weighting factor of the product-sum operation may be set in the capacitive element on the basis of a logarithmic ratio.

A weighting factor of the product-sum operation may be set in the capacitive element on the basis of a linear ratio.

The second analog signal may be input to AD converters of a plurality of pixel rows or a plurality of pixel columns, and
a weighting factor used for calculation of the calculator may be set for each of the AD converters of the plurality of pixel rows or the plurality of pixel columns.

The AD converter may perform AD conversion on the second analog signal by comparing the second analog signal with a reference signal, and
the arithmetic unit may further include a signal processing circuit that generates a voltage distribution of the second analog signal when the second analog signal exceeds the reference signal.

A voltage range of the reference signal may be optimized on the basis of the voltage distribution. This optimization processing is equivalent to performing so-called batch normalization in a circuit.

The arithmetic unit may further include a signal input/output unit that exchanges a pixel row and a pixel column of the digital signal or the second analog signal, and
the AD converter may transpose and calculate the second analog signal.

A weighting factor used when the AD converter performs AD conversion on the second analog signal may be changed from a weighting factor used when the AD conversion is performed on the first analog signal.

The signal input/output unit may include metal wiring.

The signal input/output unit may include a flip-flop.

The signal input/output unit may include a tri-state inverter.

The arithmetic unit may further include
a first substrate on which the signal detector is arranged, and
a second substrate on which the calculator is arranged, and
the first substrate and the second substrate may be laminated on top of each other.

The physical signal may include an optical signal.

The circuit elements of the signal detector may be dispersedly arranged on a plurality of substrates.

The calculator may include an analog neural network circuit.

### BRIEF DESCRIPTION OF DRAWINGS

FIG. 1 is a block diagram illustrating a schematic configuration of an arithmetic unit according to a first embodiment.

FIG. 2 is a circuit diagram illustrating a configuration example of a pixel according to the first embodiment.

FIG. 3A is a diagram illustrating a configuration of a repeater.

FIG. 3B is a diagram illustrating another configuration of the repeater.

FIG. 3C is a diagram illustrating another configuration of the repeater.

FIG. 4A is a circuit diagram illustrating a configuration of a calculator.

FIG. 4B is a circuit diagram illustrating another configuration of the calculator.

FIG. 4C is a circuit diagram illustrating another configuration of the calculator.

FIG. 4D is a circuit diagram illustrating another configuration of the calculator.

FIG. 5 is a diagram illustrating an example of a structure of the arithmetic unit according to the first embodiment.

FIG. 6 is a flowchart illustrating an operation procedure of the arithmetic unit according to the first embodiment.

FIG. 7 is a diagram illustrating an example of a structure of an arithmetic unit according to a second embodiment.

FIG. 8 is a diagram illustrating an example of a structure of an arithmetic unit according to a first modification of the second embodiment.

FIG. 9 is a diagram illustrating an example of a structure of an arithmetic unit according to a second modification of the second embodiment.

FIG. 10 is a diagram illustrating an example of a waveform of a reference signal according to a third embodiment.

FIG. 11 is a diagram illustrating an example of a result of performing AD conversion processing on an arithmetic signal first by an AD converter.

FIG. 12 is a diagram illustrating an example of a waveform of a reference signal optimized according to a voltage distribution of an arithmetic signal.

FIG. 13 is a diagram illustrating another example of the waveform of a reference signal REF optimized according to the voltage distribution of an arithmetic signal SIG2.

FIG. 14 is a block diagram illustrating an example of a schematic configuration of a vehicle control system.

FIG. 15 is an explanatory diagram illustrating an example of installation positions of an outside-vehicle information detecting section and an imaging section.

### MODE FOR CARRYING OUT THE INVENTION

Hereinafter, embodiments of an arithmetic unit according to the present disclosure will be described with reference to the drawings. Although main components of the arithmetic unit will be mainly described below, the arithmetic unit may have components and functions that are not illustrated or described. The following description is not intended to exclude components and functions that are not illustrated or described.

### First Embodiment

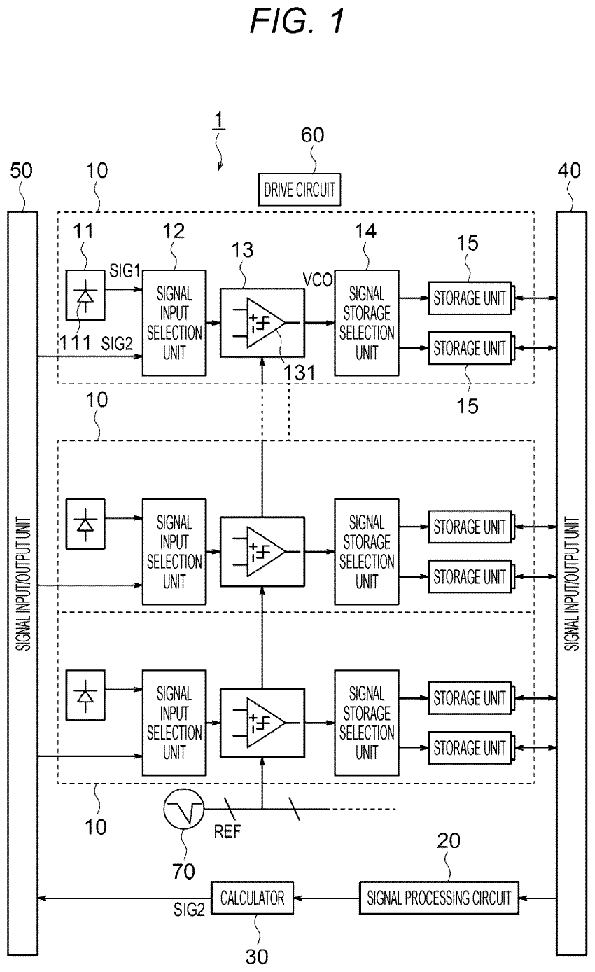

FIG. 1 is a block diagram illustrating a schematic configuration of an arithmetic unit according to a first embodiment. An arithmetic unit 1 illustrated in FIG. 1 includes a plurality of pixels 10, a signal processing circuit 20, a calculator 30, signal input/output units 40 and 50, a drive circuit 60, and a digital-to-analog (DA) converter 70.

The plurality of pixels 10 is arranged in a two-dimensional array, in other words, in a matrix. The shape of the pixel array may be a square in which the number of pixels in the row direction is the same as the number of pixels in the column direction, or may be a rectangle in which the number of pixels in the row direction is different from the number of pixels in the column direction.

Each pixel 10 includes a signal detector 11, a signal input selection unit 12, an analog to digital (AD) converter 13, a signal storage selection unit 14, and a plurality of storage units 15. The signal detector 11 outputs a first analog signal indicating the detection result of a physical signal. A physical signal is, for example, an optical signal. In this case, the first analog signal is a pixel signal SIG1 obtained by photoelectrically converting an optical signal.

The signal input selection unit 12 selects the pixel signal SIG1 or a second analog signal indicating the calculation result of the calculator 30 as an input signal to the AD converter 13. The second analog signal is, for example, an arithmetic signal SIG2 indicating the calculation result of the calculator 30.

The AD converter 13 digitally converts the pixel signal SIG1 and the arithmetic signal SIG2. In the present embodiment, the AD converter 13 is provided for each pixel 10. However, the AD converter 13 may be provided for each pixel column or may be provided for each pixel row. Furthermore, the AD converter 13 may be provided for each pixel array.

The signal storage selection unit 14 selects a storage destination of a digital signal VCO generated by the AD converter 13 from the plurality of storage units 15.

Each storage unit 15 stores a digital code supplied from the signal input/output unit 40, which is determined by the transition timing of the digital signal VCO selected by the signal storage selection unit 14. In the present embodiment, the number of the storage units 15 is two, but may be three or more. Different types of signals such as the pixel signal SIG1 of the pixel 10 and the arithmetic signal SIG2 of the calculator 30 may be stored in each storage unit 15. In addition, the storage unit 15 which is read by the signal input/output unit 40 and becomes unnecessary may be overwritten. Moreover, a plurality of adjacent storage units 15 may share and store one signal.

The signal processing circuit 20 performs predetermined signal processing such as correlated double sampling (CDS) processing on the digital signal VCO generated by the AD converter 13.

The calculator 30 performs a product-sum operation on the digital signal VCO generated by the AD converter 13 by an analog method, and outputs the calculation result as the arithmetic signal SIG2.

The signal input/output unit 40 is provided between the pixel 10 and the signal processing circuit 20. The signal input/output unit 40 reads the digital signal determined by the digital signal VCO from the storage unit 15 of each pixel 10 and outputs the digital signal to the signal processing circuit 20.

The signal input/output unit 50 is provided between the calculator 30 and the pixel 10. The signal input/output unit 50 outputs the arithmetic signal SIG2 input from the calculator 30 to the pixel 10.

The drive circuit 60 drives the arithmetic unit 1.

The DAC 70 generates a reference signal REF and outputs the reference signal REF to the AD converter 13. In the present embodiment, the reference signal REF is a slope signal whose voltage level decreases with time at a predetermined inclination.

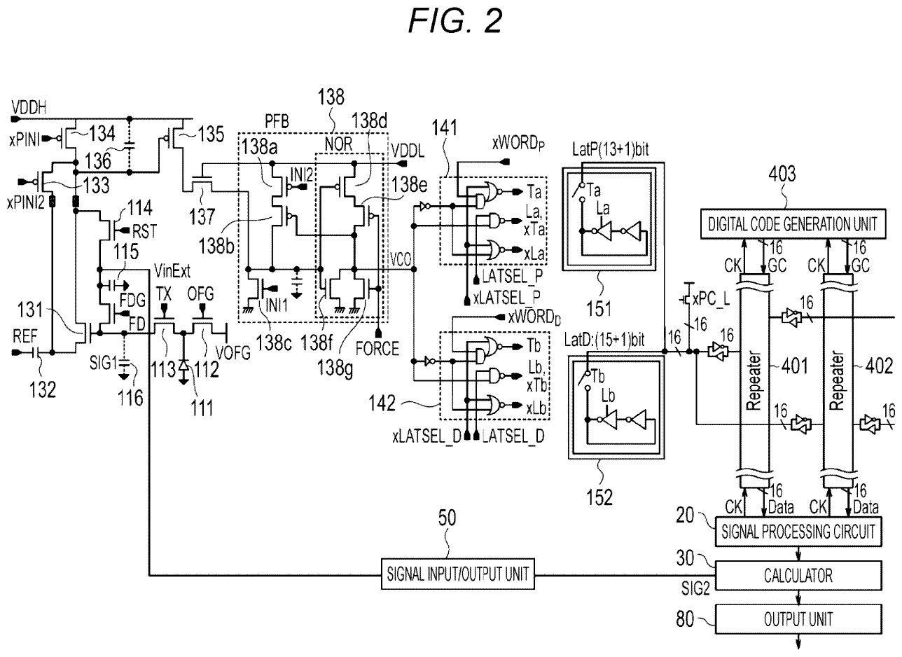

FIG. 2 is a circuit diagram illustrating a configuration example of the pixel 10 according to the first embodiment.

First, a configuration of the signal detector 11 will be described. The signal detector 11 includes a photoelectric conversion element 111, a discharge transistor 112, a transfer transistor 113, a reset transistor 114, a capacitive element 115, and a floating diffusion layer (FD) 116.

The photoelectric conversion element 111 is, for example, a photodiode (PD). The anode of the photoelectric conversion element 111 is grounded to an appropriate potential. The cathode of the photoelectric conversion element 111 is connected to the discharge transistor 112 and the transfer transistor 113. The photoelectric conversion element 111 photoelectrically converts an incident optical signal.

The discharge transistor 112 is turned on and off according to the level of a discharge signal OFG input from the drive circuit 60 to the gate. The discharge transistor 112 is used in a case where the exposure period is adjusted. Specifically, when the drive circuit 60 turns on the discharge transistor 112 when it is desired to start the exposure period at an arbitrary timing, the charge accumulated in the photoelectric conversion element 111 until then is discharged. As a result, the exposure period is started after the discharge transistor 112 is turned off.

The transfer transistor 113 is turned on and off according to the level of a transfer signal TX input from the drive circuit 60 to the gate. When the transfer transistor 113 is turned on, the charge generated by the photoelectric conversion element 111 is transferred to the floating diffusion layer 116.

The reset transistor 114 is turned on and off according to the level of a reset signal RST input from the drive circuit 60 to the gate. The reset transistor 114 resets the charge held in the floating diffusion layer 116 together with the capacitive element 115. The source of the reset transistor 114 is connected to the capacitive element 115.

The drain of the reset transistor 114 is connected to the drain of a transistor 134. The transistor 134 is turned on and off according to the level of an initialization signal xPINI input from the drive circuit 60 to the gate. When the reset transistor 114 and the transistor are turned on, the potential of the floating diffusion layer 116 is reset to the initialization potential through a power supply voltage VDDH.

The floating diffusion layer 116 generates the pixel signal SIG1 corresponding to the amount of charge transferred from the photoelectric conversion element 111. As a result, the optical signal incident on the photoelectric conversion element 111 is converted into the pixel signal SIG1.

Next, a configuration of the signal input selection unit 12 will be described. In the present embodiment, the signal input selection unit 12 is connected between the transfer transistor 113 and the reset transistor 114. The signal input selection unit 12 includes, for example, an n-channel MOS transistor. A drive signal FDG is input from the drive circuit 60 to the gate of the signal input selection unit 12. The signal input selection unit 12 is turned on and off according to the level of the drive signal FDG. When the signal input selection unit 12 is turned on, the arithmetic signal SIG2 is input to the gate of a comparison transistor 131 via the signal input selection unit 12. Conversely, when the signal input selection unit 12 is turned off, the pixel signal SIG1 is input to the gate of the comparison transistor 131. As described above, the signal input to the gate of the comparison transistor 131 is selected between the arithmetic signal SIG2 and the pixel signal SIG1 depending on the switching operation of the signal input selection unit 12.

Next, the AD converter 13 will be described. The AD converter 13 includes the comparison transistor 131, capacitive elements 132 and 136, transistors 133 to 135, a transistor 137, and a positive feedback circuit 138. In the present embodiment, the comparison transistor 131 and the transistor 137 include n-channel MOS transistors. In addition, the transistors 133 to 135 include p-channel MOS transistors. Furthermore, the comparison transistor 131, the capacitive elements 132 and 136, and the transistors 133 to 135 form a differential input circuit.

The comparison transistor 131 functions as a comparator that compares the voltage level of the pixel signal SIG1 generated in the floating diffusion layer 116 with the voltage level of the reference signal REF generated in the DAC 70. Specifically, the gate and the source of the comparison transistor 131 correspond to the input terminal of the comparator, and the drain Corresponds to the output terminal.

The transistor 133 is connected between the transistor 134 and the capacitive element 132. The transistor 133 is turned on and off according to the level of an initialization signal xPINI2 input from the drive circuit 60 to the gate. When the transistor 133 is turned on, the source potential of the comparison transistor 131, that is, the potential of one input. terminal of the comparator is reset to the power supply voltage VDDH.

The transistor 134 is connected in series with the comparison transistor 131. As described above, the transistor 134 initializes the floating diffusion layer 116 on the basis of the initialization signal xPINI input from the drive circuit 60 to the gate.

The transistor 135 outputs a signal indicating a result of comparison between the pixel signal SIG1 and the reference signal REF by the comparison transistor 131. When the voltage level of the pixel signal SIG1 becomes higher than the voltage level obtained by adding the reference signal REF and the threshold of the comparison transistor 131 and the comparison transistor 131 is turned on, the gate voltage of the transistor 135 becomes low. As a result, the transistor 135 is turned on.

One end of the capacitive element 136 is connected to the sources of the transistor 134 and the transistor 135. The other end of the capacitive element 136 is connected to the drain of the transistor 134 and the gate of the transistor 135. The capacitive element 136 accumulates charge in an electrically floating state.

The drain of the transistor 137 is connected to the drain of the transistor 135. The source of the transistor 137 is connected to the positive feedback circuit 138. A power supply voltage VDDL is applied to the gate of the transistor 137. The power supply voltage VDDL is lower than the power supply voltage. The transistor 137 converts the output signal of the transistor 135 into a signal of a low voltage at which the positive feedback circuit 138 can operate, and supplies the signal to the positive feedback circuit 138.

The positive feedback circuit 138 is a circuit that operates at the power supply voltage VDDL. The positive feedback circuit 138 outputs, as the digital signal VCO, a comparison result signal that is inverted when the pixel signal SIG1 is higher than the reference signal REF, on the basis of the signal supplied from the transistor 137.

The positive feedback circuit 138 includes transistors 138a to 138g. In the present embodiment, the transistors 138a, 138b, 138d, and 137e include p-channel MOS transistors. In Addition, the transistors 138c, 138f, and 138g include n-channel MOS transistors. The transistors 138d to 138q form a NOR circuit.

The source of the transistor 137 is connected to the drains of the transistor 138b and the transistor 138c, and the gates of the transistor 138d and the transistor 138f. The sources of the transistor 138a and the transistor 138d are connected to the power supply voltage VDDL. The drain of the transistor 138a is connected to the source of the transistor 138b. The gate of the transistor 138b is connected to the drains of the transistors 138e, 138f, and 138g, which are also output terminals of the positive feedback circuit 138. The sources of the transistors 138c, 138f, and 138g are grounded. Initialization signals INI2 and INI1 are input from the drive circuit 60 to the gates of the transistor 138a and the transistor 138c, respectively. A FORCE signal is input from the drive circuit 60 to the gates of the transistor 138e and the transistor 138g.

A connection point between the drains of the transistors 138e, 138f, and 138g is an output terminal at which the AD converter 13 outputs the digital signal VCO.

Next, a configuration of the signal storage selection unit 14 will be described. The signal storage selection unit 14 includes a signal control unit 141 and a signal control unit 142. In the present embodiment, the signal control unit 141 and the signal control unit 142 include multiplexers. The digital signal VCO generated by the AD converter 13 is input to one input terminals of the signal control unit 141 and the signal control unit 142. Furthermore, a WORDE signal and a WORD_{D} signal are input to the other input terminals of the signal control unit 141 and the signal control unit 142. Outputs of the signal control units 141 and 142 are connected to the storage unit 15.

For example, the signal control unit 141 controls an operation of writing a digital code supplied from the signal input/output unit 40 determined by the digital signal VCO output from the AD converter 13 in a reset period (P-phase period) in which the transfer transistor 113 is turned off before exposure to a first storage unit 151 connected to the signal control unit 141 among the plurality of storage units 15. In addition, the signal control unit 142 controls an operation of writing a digital code supplied from the signal input/output unit 40 determined by the digital signal VCO obtained by digitally converting the pixel signal SIG1 by the AD converter 13 in a data transfer period (D-phase period) in which the transfer transistor 113 is turned on after exposure to a second storage unit 152 connected to the signal control unit 142 among the plurality of storage units 15. Furthermore, the signal control unit 141 or the signal control unit 142 controls an operation of writing a digital code supplied from the signal input/output unit 40 determined by the digital signal VCO obtained by digitally converting the arithmetic signal SIG2 by the AD converter 13 in a period in which the signal input selection unit 12 is turned on to the first. storage unit 151 or the second storage unit 152.

Next, configurations of the first storage unit 151 and the second storage unit 152 will be described. The first storage unit 151 and the second storage unit 152 include latch circuits. Moreover, switches Ta and Tb are provided in the latch circuits of the first storage unit 151 and the second storage unit 152, respectively. When the switches Ta and Tb are turned on, the data of the digital signal VCO is written in the first storage unit 151 and the second storage unit 152. Thereafter, when the switches Ta and Tb are turned off, the data stored in the first storage unit 151 and the second storage unit 152 is finalized.

Next, a configuration of the signal input/output unit 40 will be described. The signal input/output unit. 40 includes a repeater 401 and a repeater 402. The repeater 401 and the repeater 402 perform an operation of writing data into the first storage unit 151 and the second storage unit 152 on the basis of the control of the signal control units 141 and 142. In addition, the repeater 401 and the repeater 402 perform an operation of reading data from the first storage unit 151 and the second storage unit 152 on the basis of the control of the signal control units 141 and 142.

A digital time code is supplied from a digital code generation unit 403 to the repeater 401 and the repeater 402. The data output from each storage unit to each repeater is output to the signal processing circuit 20.

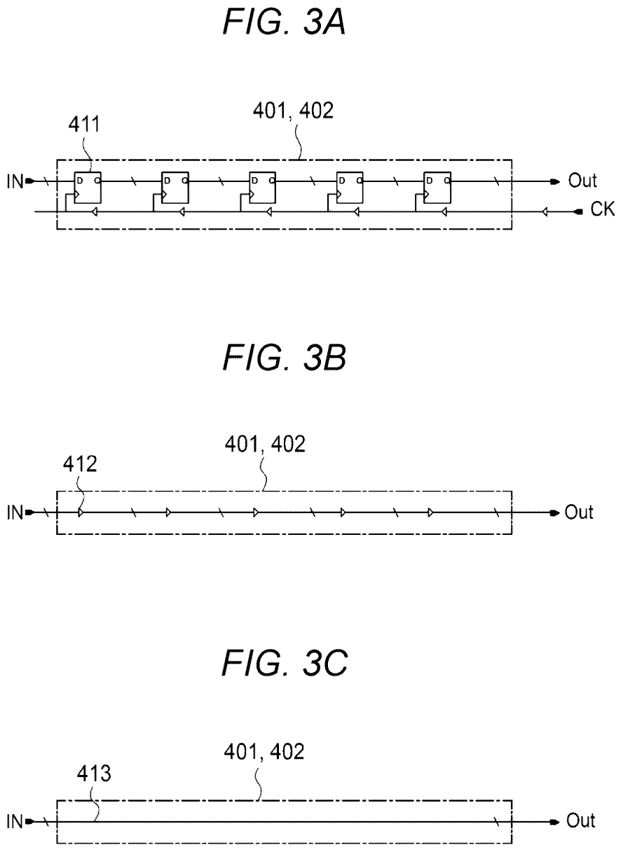

FIGS. 3A to 3C are diagrams illustrating configurations of the repeaters 401 and 402. The repeaters 401 and 402 illustrated in FIG. 3A include multistage flip-flops 411. A control clock signal CK is input to each flip-flop 411. Although the repeaters 401 and 402 may be configured like a clock tree and synchronize the control timing of the flip-flops 411 with respect to the control clock signal CK, it is assumed that this configuration increases area and power. Therefore, in the repeaters 401 and 402, the input direction of the control clock signal CK is desirably opposite to the signal output direction of the flip-flop 411.

The repeaters 401 and 402 illustrated in FIG. 3B include a plurality of tri-state inverters 412. In this case, a control signal for achieving tri-state output is input from the drive circuit 60 to each tri-state inverter 412.

The repeaters 401 and 402 illustrated in FIG. 3C include metal wiring 413 that transmits the digital signal VCO. In this case, the configuration of the repeaters 401 and 402 can be simplified as compared with those in FIGS. 3A and 3B.

The configurations of the repeaters 401 and 402 illustrated in FIGS. 3A to 3C can also be applied to the signal input/output unit 50 illustrated in FIG. 1. In this case, each repeater outputs the arithmetic signal SIG2 output from the calculator 30 to the corresponding signal input selection unit 12.

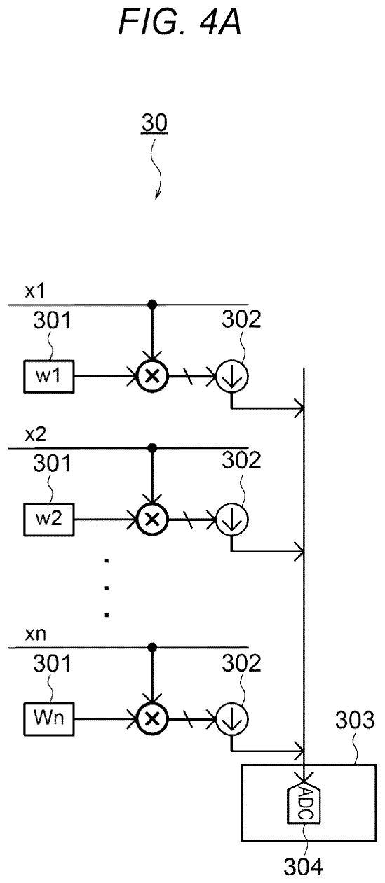

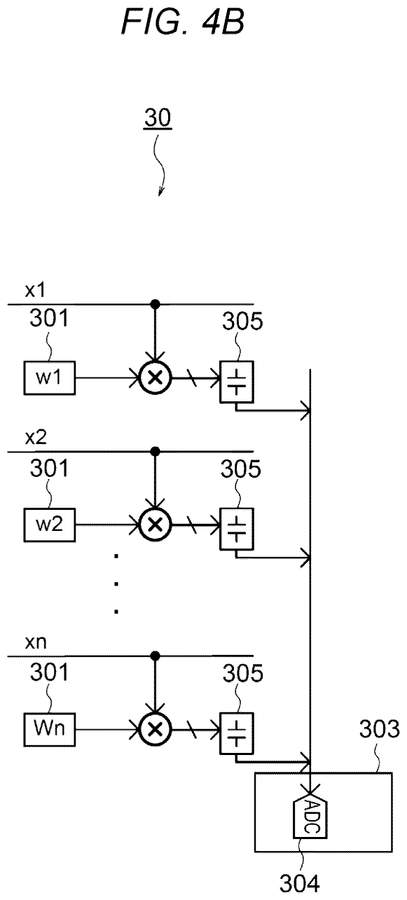

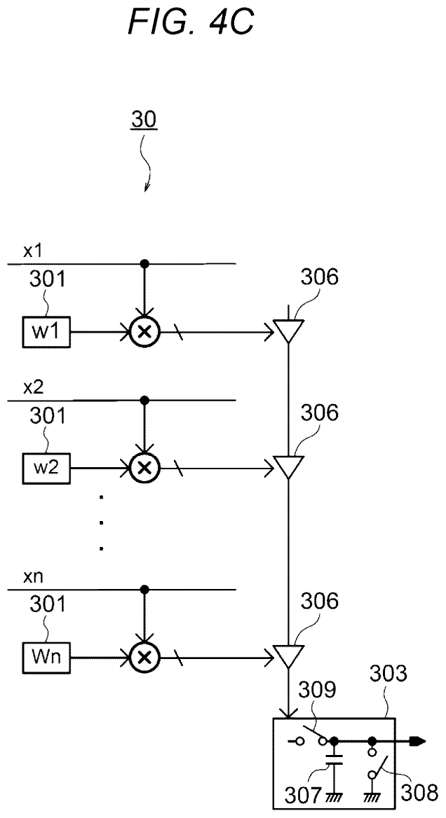

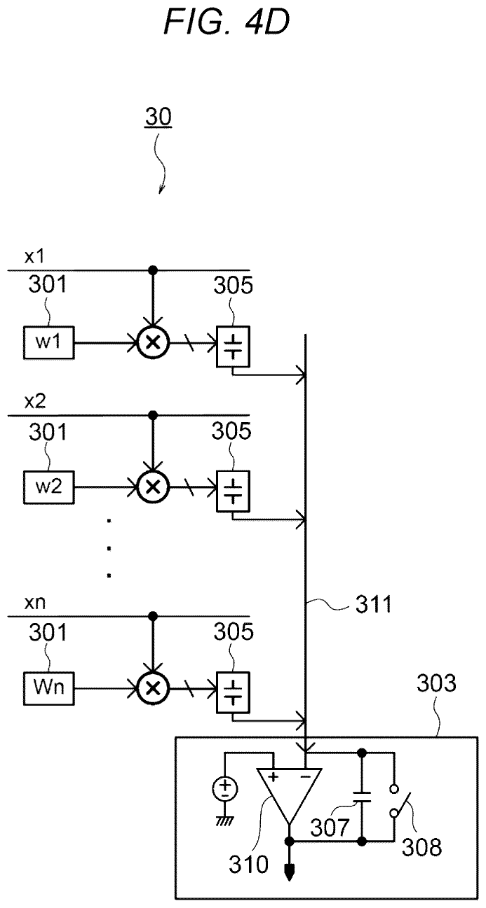

Hereinafter, a configuration example of the calculator 30 will be described with reference to FIGS. 4A to 4D.

The calculator 30 illustrated in FIG. 4A includes a plurality of memory cells 301, a plurality of current sources 302, and a read circuit 303. The plurality of memory cells 301 is arranged in a two-dimensional array. For example, a resistive random access memory (ReRAM), a phase change memory (PCM), a magneto resistive random access memory (MRAM), a ferroelectric random access memory (FeRAM), or the like can be applied to each memory cell 301. Furthermore, the memory cell 301 may be a static random access memory (SRAM) or a nonvolatile memory. Each memory cell 301 holds weighting factors W1 to Wn.

The plurality of current sources 302 includes, for example, MOS transistors. The plurality of current sources 302 are individually connected to the plurality of memory cells 301. The read circuit 303 includes an AD converter 304.

In the calculator 30 configured as described above, input signals x1 to xn input from the signal processing circuit 20 are multiplied by the weighting factors W1 to Wn of the memory cells 301. The multiplied value is converted into a current value in each current source 302. The current values of the current sources 302 are added and input to the read circuit 303. In the read circuit 303, the AD converter 304 performs analog conversion on the added current value. As a result, the arithmetic signal SIG2 is generated.

The calculator 30 illustrated in FIG. 4B is different from the calculator 30 illustrated in FIG. 4A in that a plurality of capacitive elements 305 is included instead of the plurality of current sources 302. Charge indicating multiplication results of the input signals x1 to xn and the weighting factors W1 to Wn is held in each of the capacitive elements 305. The charge held in each of the capacitive elements 305 is added and input to the read circuit 303. In the read circuit 303, the AD converter 304 performs analog conversion on the added charge. As a result, the arithmetic signal SIG2 is generated.

The calculator 30 illustrated in FIG. 4B is an analog neural network circuit that enables product-sum operation based on charge by changing the capacitance value of the capacitive element 305. Since the calculator 30 is not affected by settling variations by securing a signal establishment time, and the capacitance value is relatively less likely to vary than the resistance value, the arithmetic accuracy becomes higher than the resistance.

The calculator 30 illustrated in FIG. 4C is different from the calculator 30 illustrated in FIG. 4A in that a plurality of inverter elements 306 is included instead of the plurality of current sources 302 and that the configuration of the read circuit 303 is different. The read circuit 303 includes a capacitive element 307 and switches 308 and 309.

The switch 309 is connected in series to the inverter element 306. The switch 308 and the capacitive element 307 are connected in parallel to the switch 309. The switch 308 and the switch 309 include, for example, MOS transistors driven and controlled by the drive £ circuit 60.

In the calculator 30 illustrated in FIG. 4C, multiplication values of the input signals x1 to xn and the weighting factors W1 to Wn are input to the respective inverter elements 306. The multiplication value is added by each inverter element 306 and input to the read circuit 303. In the read circuit 303, the added value is once converted into a voltage by calculation with time, and the voltage value corresponds to the arithmetic signal SIG2. The time calculation is performed by the delay of the inverter element 306, and the time for charging the charge to the capacitive element 307 according to the delay amount can be made variable by the switch 308 and the switch 309.

The calculator 30 illustrated in FIG. 4D is different from the calculator 30 illustrated in FIG. 4A in that a plurality of capacitive elements 305 is included instead of the plurality of current sources 302 and that the configuration of the read circuit 303 is different. The read circuit 303 includes an integrator. Specifically, the read circuit 303 includes a capacitive element 307, a switch 308, and an operational amplifier 310.

The switch 308 and the capacitive element 307 are connected in parallel between the inverting input terminal (−) and the output terminal of the operational amplifier 310. A predetermined voltage is applied to the non-inverting input terminal (+) of the operational amplifier 310. In the read circuit 303, charge is read by feedback to the capacitive element 307 which is a feedback capacitance connected between the input and output terminals of the operational amplifier 310.

In the calculator 30 illustrated in FIG. 4D, each of the capacitive elements 305 holds charge indicating multiplication results of the input signals x1 to xn and the weighting factors W1 to Wn. The charge held in each of the capacitive elements 305 is added and input to the read circuit 303. In the read circuit 303, the arithmetic signal SIG2 is output from the output terminal of the operational amplifier 310.

According to the calculator 30 illustrated in FIG. 4D, the influence of the capacitance division at the time of reading due to the parasitic capacitance present in read wiring 311 can be reduced by reading the signal using the integrator. Note that in the calculator 30, a weighting factor may be set for each of the capacitive elements 305 at a power ratio of 2. Alternatively, each of the capacitive elements 305 may have a weighting factor set in logarithmic ratio. Alternatively, each of the capacitive elements 305 may have a weighting factor set by a linear ratio. The input signal of the calculator 30 is a digital signal supplied from the outside through the signal input/output unit 40, and in particular, the digital signal VCO indicates an acquisition timing thereof. FIG. 4D illustrates multiplication of the weighting factor w and the input X, and illustrates the capacitive element 305 for charge calculation. In an actual circuit configuration in the calculator 30, a capacitance value (size) C of the capacitive element 305 changes depending on the weighting factor w. The signal amount accumulated in the capacitance value C varies depending on the weighting factor w.

In addition, in a case where the weighting factor is set as a logarithmic ratio, the set value of the capacitance value C increases logarithmically, such as 0.3, 0.47, 0.6, and 0.69, for example. Each of these logarithms corresponds to, for example, 2, 3, 4, 5 digital codes.

Further, when the weighting factor is set as a linear ratio, the linear ratio has a linear relationship between the setting value of the capacitance value C and the weighting factor w. For example, when the capacitance value C is set to 1, 2, 3, 4, 5 . . . , the weighting factor w corresponding to each capacitance value C is also 1, 2, 3, 4, 5 . . . .

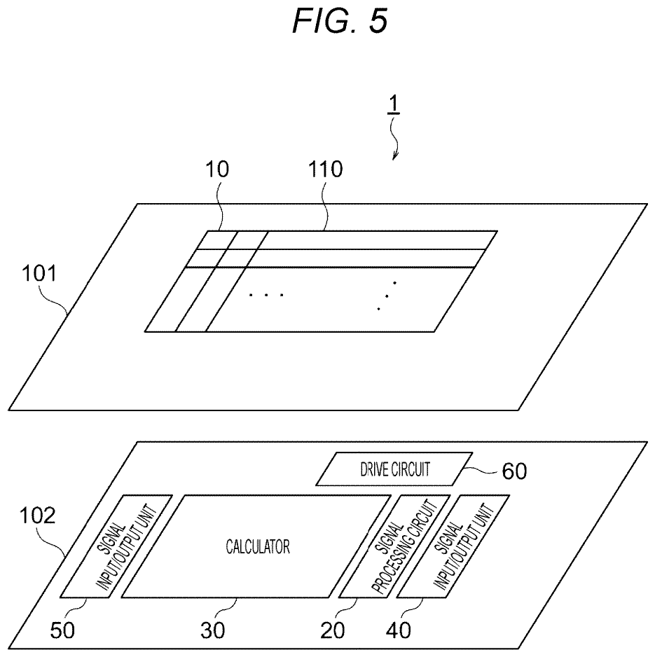

FIG. 5 is a diagram illustrating an example of a structure of the arithmetic unit 1 according to the first embodiment. As illustrated in FIG. 5, the arithmetic unit 1 has a laminated structure in which a first substrate 101 and a second substrate 102 are laminated.

The first substrate 101 and the second substrate 102 are, for example, silicon substrates. The first substrate 101 and the second substrate 102 are electrically connected by, for example, so-called Cu—Cu bonding in which connection terminals are bonded to each other. Note that other than Cu—Cu bonding, through silicon via (TSV) bonding using a through electrode, microbump bonding, magnetic coupling, or the like may be applied to the method of bonding the first substrate 101 and the second substrate 102.

In the present embodiment, a pixel array 110 is arranged on the first substrate 101. In the pixel array 110, a plurality of pixels 10 is arranged in a two-dimensional array. On the other hand, the signal processing circuit 20, the calculator 30, the signal input/output units 40 and 50, and the drive circuit 60 are arranged on the second substrate 102. Note that in the present embodiment, the first substrate 101 may further include two laminated substrates. In this case, in the signal detector 11, the photoelectric conversion element 111 may be arranged on one laminated substrate, and the remaining circuit elements may be arranged on the other laminated substrate. In this manner, by dispersedly arranging the circuit elements of the signal detector 11 on a plurality of substrates, it is possible to sufficiently secure the light receiving area of the optical signal.

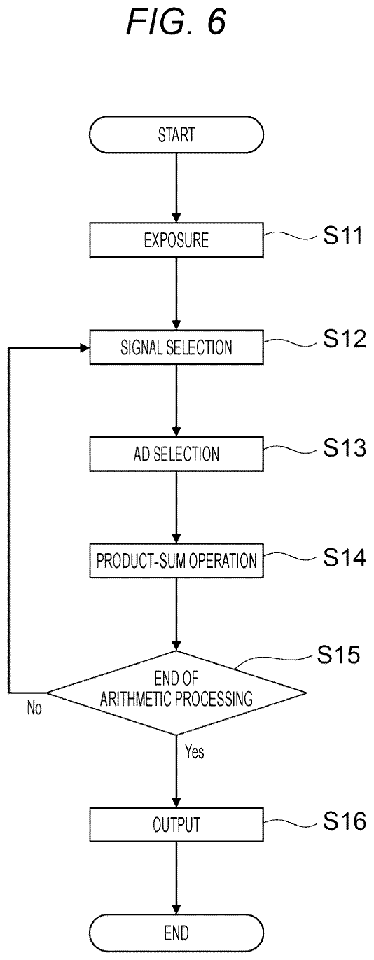

FIG. 6 is a flowchart illustrating an operation procedure of the arithmetic unit 1 according to the first embodiment. Hereinafter, the operation of the arithmetic unit 1 according to the first embodiment will be described with reference to FIG. 6. Note that here, the operation after exposure is started will be described.

In the flowchart illustrated in FIG. 6, first, exposure is started (step S11). In step S11, the photoelectric conversion element 111 of each pixel 10 photoelectrically converts the optical signal. Before transfer, an initial state of the circuit is set as a reset level of the circuit, and AD conversion is performed through the signal input selection unit 12, the AD converter 13, the signal storage selection unit 14, and the storage unit 15. Next, the signal input selection unit 12 performs an operation of selecting a signal to be input to the AD converter 13 (step S12). As a result, the pixel signal generated in step S11 is input to the AD converter 13.

Subsequently, the transfer transistor 113 transfers the charge photoelectrically converted by the photoelectric conversion element 111 to the floating diffusion layer 116. The floating diffusion layer 116 converts the charge transferred from the transfer transistor 113 into the pixel signal SIG1. In step S11 of the present embodiment, a global shutter operation is performed in which all the pixels 10 simultaneously detect optical signals.

Next, the AD converter 13 performs AD conversion on the input signal, which is the pixel signal SIG1 in this example (step S13). In step 813, the AD converter 13 Converts the pixel signal SIG1 into a digital signal supplied from the signal input/output unit 40 determined by the digital signal VCO. This digital signal is stored in the storage unit 15 stored by the signal storage selection unit 14. Subsequently, the digital signal is read from the storage unit 15 by the signal input/output unit 40 and input to the signal processing circuit 20. The signal processing circuit 20 performs predetermined signal processing on the digital signal. This is, for example, processing such as correlated double sampling for obtaining a difference between a reset level and a signal level. This result becomes the pixel signal SIG1. Subsequently, the digital signal subjected to the signal processing is input to the calculator 30.

Next, the calculator 30 performs a product-sum operation on the digital signal (step S14). In step S14, the arithmetic signal SIG2 is generated by the product-sum operation processing of the calculator 30. The generated arithmetic signal SIG2 is input to the AD converter 13 of each pixel 10 by the signal input/output unit 50.

In the present embodiment, the calculator 30 is set to perform the product-sum operation a plurality of times. Therefore, the arithmetic processing is not ended until the number of product-sum operations reaches the preset number of times (step S15). When the arithmetic processing is not ended (step S15: No), the operations of steps S12 to S15 are repeated. In this case, in step S12, the signal input selection unit 12 selects the arithmetic signal SIG2 as an input signal to the AD converter 13. Therefore, the signal input selection unit 12 including the MOS transistor is turned on. As a result, the arithmetic signal SIG2 generated in step S14 is input to the AD converter 13 through the signal input selection unit 12.

When the arithmetic processing ends (step S15: YES), the arithmetic signal SIG2 is output from the output unit 80 to the outside (step S16). As a result, the operation of the arithmetic unit 1 ends.

According to the present embodiment described above, the digital signal input to the calculator 30 is output as the analog arithmetic signal SIG2. In addition, the arithmetic signal SIG2 is fed back to the signal input selection unit 12 connected to the input terminal of the AD converter 13. As a result, the operation loop of the calculator 30 can be implemented by the shortest data transmission path. As a result, high power efficiency can be obtained, and power consumption can be suppressed.

### Second Embodiment

Next, a second embodiment of the present disclosure will be described. In the present embodiment, the same components as those in the first embodiment are denoted by the same reference numerals, detailed description thereof is omitted, and differences from the first embodiment will be mainly described.

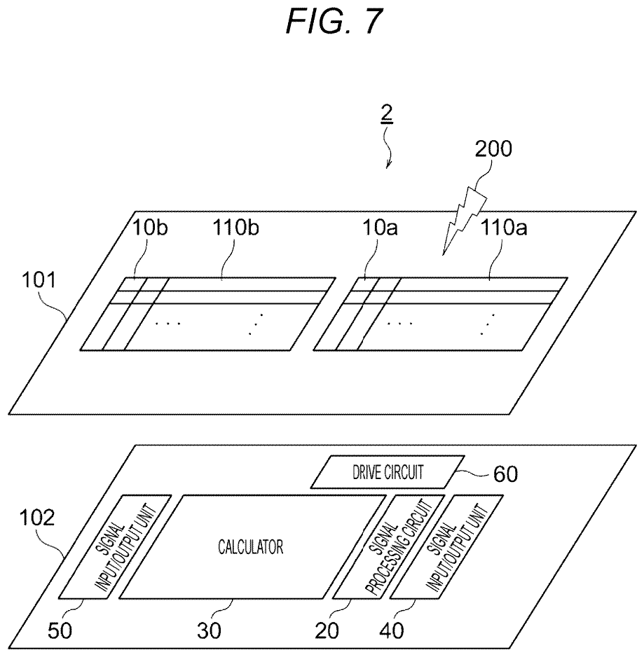

FIG. 7 is a diagram illustrating an example of a structure of an arithmetic unit according to the second embodiment. The arithmetic unit 2 illustrated in FIG. 7 £ includes a first pixel array 110a and a second pixel array 110b. The first pixel array 110a and the second pixel array 110b are arranged apart from each other on a first substrate 101. That is, a space is formed between the first pixel array 110a and the second pixel array 110b. Note that the shape of the first pixel array 110a and the shape of the second pixel array 110b may both be square or rectangular, or one may be square and the other may be rectangular.

In the first pixel array 110a, a plurality of first pixels 10a is arranged in a two-dimensional array. Similarly to the pixel 10 described in the first embodiment, each first pixel 10a is an effective pixel including a signal detector 11, a signal input selection unit 12, an AD converter 13, a signal storage selection unit 14, and a storage unit 15. Therefore, in each first pixel 10a, an optical signal 200 is photoelectrically converted into a pixel signal SIG1 by the signal detector 11. Furthermore, the pixel signal SIG1 is AD-converted into a digital signal by the AD converter 13, undergoes CDS processing and the like through a signal processing circuit 20, and then becomes an AD conversion signal of the pixel signal SIG1.

On the other hand, in the second pixel array 110b, a plurality of second pixels 10b is arranged in a two-dimensional array. Similarly to the pixel 10 described in the first embodiment, each second pixel 10b also includes a signal detector 11, a signal input selection unit 12, an AD converter 13, a signal storage selection unit 14, and a storage unit 15. Note, however, that each second pixel 10b is an optical black (OPB) pixel that detects a black level. Therefore, a photoelectric conversion element 111 of the second pixel 10b is shielded by a light shielding film.

An arithmetic signal SIG2 of a calculator 30 is input to the second pixel 10b. At this time, the MOS transistor forming the signal input selection unit 12 of the second pixel 10b is turned on. Therefore, the arithmetic signal SIG2 is AD-converted into a digital signal VCO by the AD converter 13 of the second pixel 10b.

As described above, in the present embodiment, the AD converter 13 that performs AD conversion on the pixel signal SIG1 and the AD converter 13 that performs AD conversion on the arithmetic signal SIG2 are physically separated in the first substrate 101. In other words, two AD converters 13 having different AD conversion targets are arranged in different areas (pixel arrays). Even in such a layout, the arithmetic loop of the calculator 30 is repeated between the first substrate 101 and the second substrate 102. Therefore, also in the present embodiment, since the operation loop of the calculator 30 can be implemented by the shortest data transmission path, power consumption can be suppressed.

Note that in the present embodiment, in a case where the pixel signal SIG1 is selected in the signal selection processing (step S12), in the AD conversion processing (step S13), only the AD converter 13 of the first pixel 10a performs the AD conversion processing of generating a digital signal. On the other hand, in a case where the arithmetic signal SIG2 is selected in the signal selection processing (step S12), in the AD conversion processing (step S13), only the AD converter 13 of the second pixel 10b performs the AD conversion processing of generating the digital signal. A region of interest (ROI) function can be achieved by performing the AD conversion processing only in the pixel array of the detection target of the digital signal in this manner.

Furthermore, in the present embodiment, the AD conversion processing may be performed in both the first pixel 10a and the second pixel 10b in the AD conversion processing (step S13). At this time, in a case where the pixel signal SIG1 is selected in the signal selection processing (step S12), the signal input/output unit 40 inputs only the digital signal generated in the first pixel 10a to the signal processing circuit 20. Thereafter, the digital signal is subjected to signal processing by the signal processing circuit 20 and input to the calculator 30. On the other hand, in a case where the arithmetic signal SIG2 is selected in the signal selection processing (step S12), the signal input/output unit 40 inputs only the digital signal generated in the second pixel 10b to the signal processing circuit 20. Thereafter, the digital signal is subjected to signal processing by the signal processing circuit 20 and input to the calculator 30. As described above, a region of interest (ROI) function can also be achieved by inputting only a digital signal of a specific pixel array to the calculator 30.

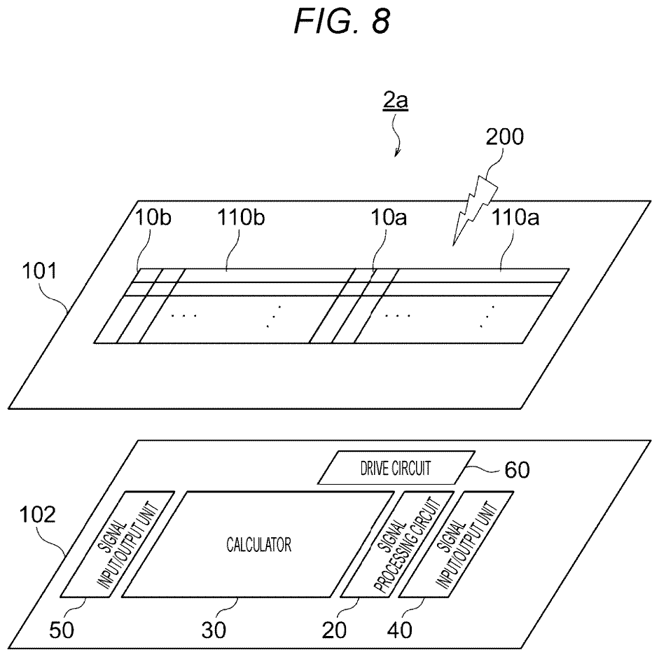

FIG. 8 is a diagram illustrating an example of a structure of an arithmetic unit according to a first modification of the second embodiment. In an arithmetic unit 2a according to the first modification, a first pixel array 110a and a second pixel array 110b are arranged adjacent to each other on a first substrate 101. Even in such a layout, an AD converter 13 of a first pixel 10a and an AD converter 13 of a second pixel 10b are physically separated.

Therefore, when the first pixel 10a and the second pixel 10b are driven in the same manner as in the second embodiment, the arithmetic loop of a calculator 30 is repeated between the first substrate 101 and a second substrate 102. Therefore, also in the present modification, since the operation loop of the calculator 30 can be implemented by the shortest data transmission path, power consumption can be suppressed.

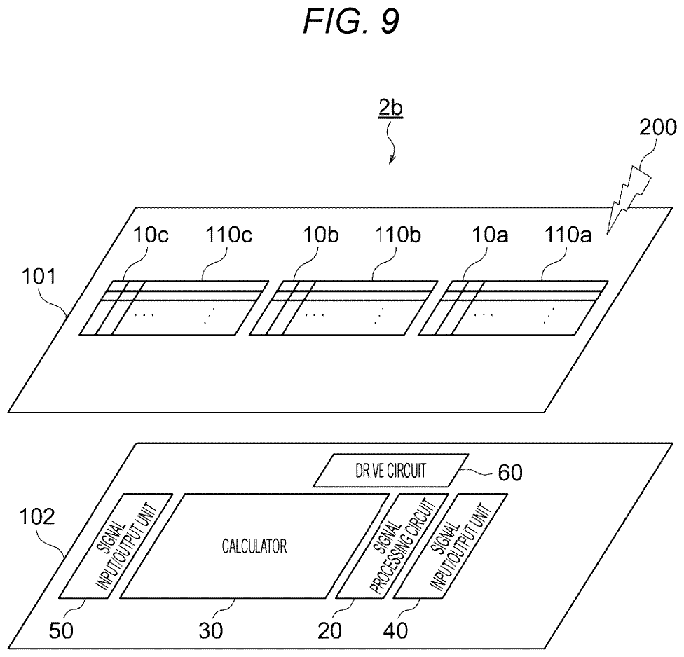

FIG. 9 is a diagram illustrating an example of a structure of an arithmetic unit according to a second modification of the second embodiment. An arithmetic unit 2b according to the first modification further includes a third pixel array 110c in addition to a first pixel array 110a and a second pixel array 110b. The third pixel array 110c is arranged on a first substrate 101 together with the first pixel array 110a and the second pixel array 110b.

In the third pixel array 110c, third pixels 10c are arranged in a two-dimensional array. An arithmetic signal SIG2 of a calculator 30 is input to the third pixel 10c. An AD converter 13 of the third pixel 10c performs AD conversion only on the arithmetic signal SIG2. That is, in the arithmetic unit 2b according to the present modification, a pixel signal SIG1 is AD-converted only by an AD converter 13 of a first pixel 10a, and the arithmetic signal SIG2 is AD-converted only by the AD converter 13 of the third pixel 10c.

According to the present modification, since the AD converter 13 dedicated to the arithmetic signal SIG2 is provided as described above, a signal input selection unit 12 is unnecessary in the third pixel 10c. As a result, the circuit configuration of the third pixel 10c can be simplified.

### Third Embodiment

Next, a third embodiment of the present disclosure will be described. Since the configuration of the arithmetic unit according to the present embodiment is similar to that of the arithmetic unit 1 according to the first embodiment or the arithmetic unit 2 according to the second embodiment, detailed descriptions thereof will be omitted.

In the first embodiment and the second embodiment described above, regardless of whether the AD conversion target by the AD converter 13 is the pixel signal SIG1 or the arithmetic signal SIG2, the DAC 70 outputs the same reference signal REF to the AD converter 13, specifically, to the source of the comparison transistor 131. On the other hand, in the present embodiment, a DAC 70 outputs different reference signals depending on the AD conversion target.

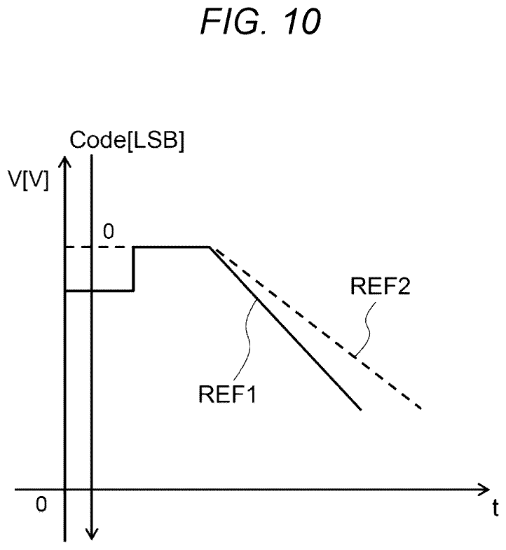

FIG. 10 is a diagram illustrating an example of a waveform of a reference signal according to the third embodiment. In FIG. 10, the horizontal axis represents time, and the vertical axis represents the voltage of the reference signal. In the present embodiment, when an AD converter 13 performs AD conversion on a pixel signal SIG1, the DAC 70 outputs a first reference signal REF1 to the source of a comparison transistor 131. On the other hand, when the AD converter 13 performs AD conversion on an arithmetic signal SIG2, the DAC 70 outputs a second reference signal REF2 to the source of the comparison transistor 131.

An inclination of the first reference signal REF1 is different from an inclination of the second reference signal REF2. In the present embodiment, the inclination of the first reference signal REF1 is larger than the inclination of the second reference signal REF2, but the relative magnitudes of the inclinations may be reversed.

Furthermore, in the present embodiment, the DAC 70 outputs two types of reference signals having different inclinations, but may output three or more types of reference signals. In this case, at the time of AD conversion of the arithmetic signal SIG2, the DAC 70 may output, for example, a reference signal having a different inclination for each region in a pixel array 110. Alternatively, for example, the DAC 70 may output reference signals having different inclinations in the first AD conversion and the second AD conversion.

As described above, the DAC 70 outputs a plurality of types of reference signals having different inclinations, so that it is possible to set a specific weighting to the arithmetic signal SIG2.

Furthermore, in the first embodiment and the second embodiment described above, the digital signal is read out in the order of the pixel row and the pixel column by the signal input/output unit 40 and input to the calculator 30, and the arithmetic signal SIG2 is input to the AD converter 13 of the same pixel 10 as the corresponding pixel signal SIG1 by the signal input/output unit 50. On the other hand, in the present embodiment, for example, the signal input/output unit 40 may input the digital signal to the calculator 30 by switching the pixel column and the pixel row of the pixel array 110, or the signal input/output unit 50 may input the arithmetic signal SIG2 to the AD converter 13 by switching the pixel column and the pixel row. As a result, it is possible to transpose the arithmetic signal SIG2.

Furthermore, the pixel signal SIG1 is first input to the AD converter 13 of each pixel 10. Therefore, in the first embodiment and the second embodiment described above, the reference signal REF input from the DAC 70 to the AD converter 13 is optimized on the basis of the pixel signal SIG1. However, the reference signal REF is not necessarily optimal for the arithmetic signal SIG2.

Therefore, in the present embodiment, processing of optimizing a reference signal REF is performed according to the result of the AD conversion processing of the arithmetic signal SIG2 by the AD converter 13. Hereinafter, the optimization processing of the reference signal REF will be described.

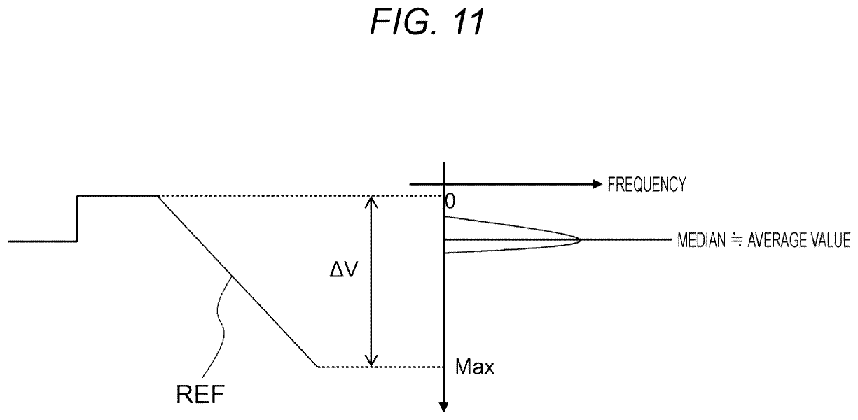

FIG. 11 is a diagram illustrating an example of a result of performing AD conversion processing on the arithmetic signal SIG2 first by the AD converter 13. FIG. 11 illustrates a distribution indicating a comparison result between the arithmetic signal SIG2 of each pixel 10 and the reference signal REF in association with a waveform of the reference signal REF. This distribution is created by, for example, a signal processing circuit 20.

In the distribution illustrated in FIG. 11, the median (average value) of the voltage distribution of the arithmetic signal SIG2 when exceeding the reference signal REF is biased toward the end of a voltage range ΔV of the reference signal REF. In this case, a maximum value Max and a minimum value Min of the voltage of the arithmetic signal SIG2 when exceeding the reference signal REF are calculated by the signal processing circuit 20. Subsequently, the DAC 70 optimizes the reference signal REF such that the median value (Max+Min)/2 of the voltage is at the center of the voltage range ΔV.

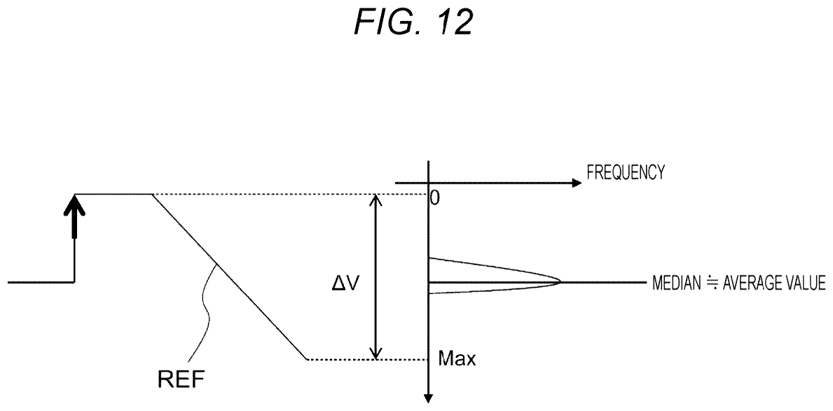

FIG. 12 is a diagram illustrating an example of a waveform of the reference signal REF optimized according to the voltage distribution of the arithmetic signal SIG2. In the reference signal REF illustrated in FIG. 12, the inclination start offset voltage is higher than that of the reference signal REF illustrated in FIG. 11. As a result, the median (average value) of the voltage distribution of the arithmetic signal SIG2 moves to the center of the voltage range ΔV of the reference signal REF.

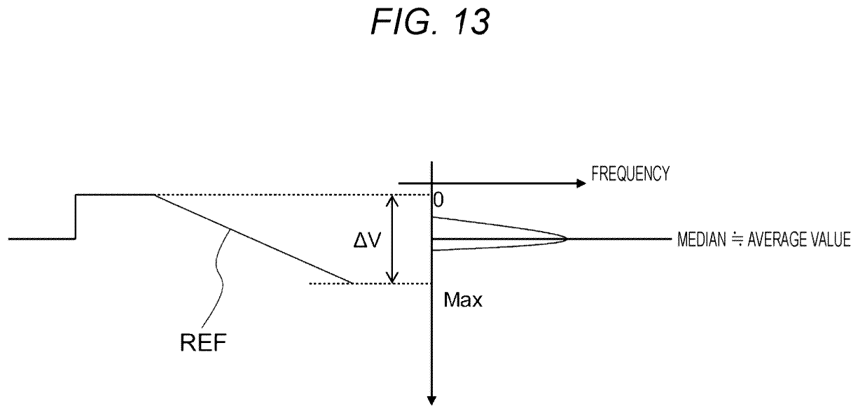

FIG. 13 is a diagram illustrating another example of the waveform of the reference signal REF optimized according to the voltage distribution of the arithmetic signal SIG2. The reference signal REF illustrated in FIG. 13 has an inclination smaller than that of the reference signal REF illustrated in FIG. 12. Also in this case, the median (average value) of the voltage distribution of the arithmetic signal SIG2 moves to the center of the voltage range ΔV of the reference signal REF.

By optimizing the reference signal REF as described above, the calculation accuracy can be improved. Note that in the present embodiment, both of the method illustrated in FIG. 12 and the method illustrated in FIG. 13 may be used as the method of optimizing the reference signal REF. In this case, the reference signal REF can be further optimized.

### Example of Application to Mobile Body

The technology according to the present disclosure (present technology) can be applied to various products. For example, the technology according to the present. disclosure may also be implemented as a device mounted on any type of mobile body such as an automobile, an electric automobile, a hybrid electric automobile, a motorcycle, a bicycle, a personal mobility, an airplane, a drone, a ship, and a robot.

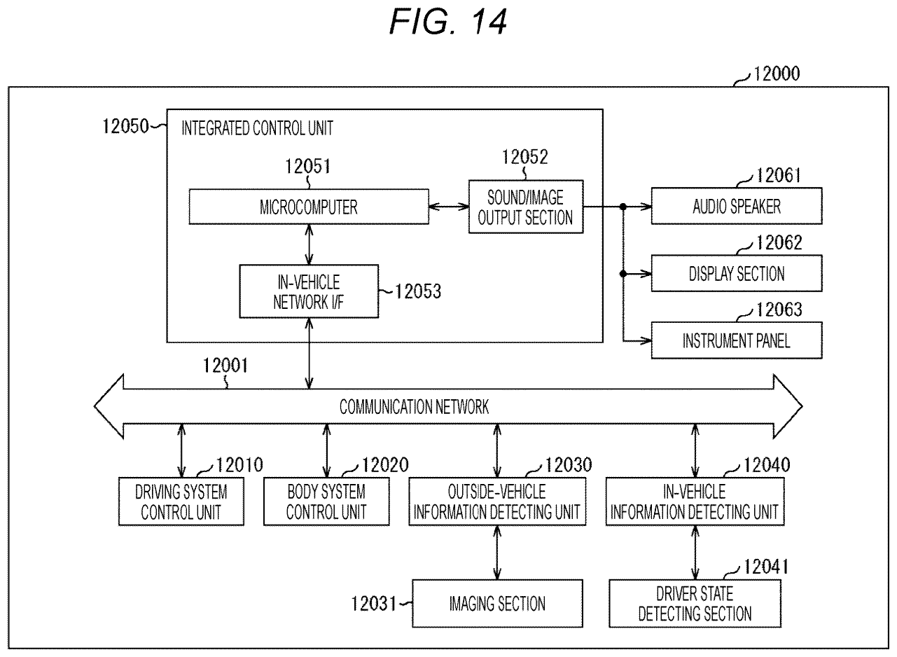

FIG. 14 is a block diagram illustrating a schematic configuration example of a vehicle control system which is one example of a mobile body control system to which the technology according to the present disclosure can be applied.

The vehicle control system 12000 includes a plurality of electronic control units connected to each other via a communication network 12001. In the example illustrated in FIG. 14, the vehicle control system 12000 includes a driving system control unit. 12010, a body system control unit 12020, an outside-vehicle information detecting unit 12030, an in-vehicle information detecting unit 12040, and an integrated control unit 12050. Furthermore, as a functional configuration of the integrated control unit 12050, a microcomputer 12051, a sound/image output section 12052, and an in-vehicle network interface (I/F) 12053 are illustrated.

The driving system control unit 12010 controls the operation of devices related to the driving system of the vehicle in accordance with various kinds of programs. For example, the driving system control unit 12010 functions as a control device for a driving force generating device for generating the driving force of the vehicle such as an internal combustion engine or a driving motor, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device that can visually or auditorily notify an occupant or the outside of the vehicle of information. In the example in FIG. 14, an audio speaker 12061, a display section 12062, and an instrument panel 12063 are exemplified as the output device. The display section 12062 may include, for example, at least one of an on-board display or a head-up display.

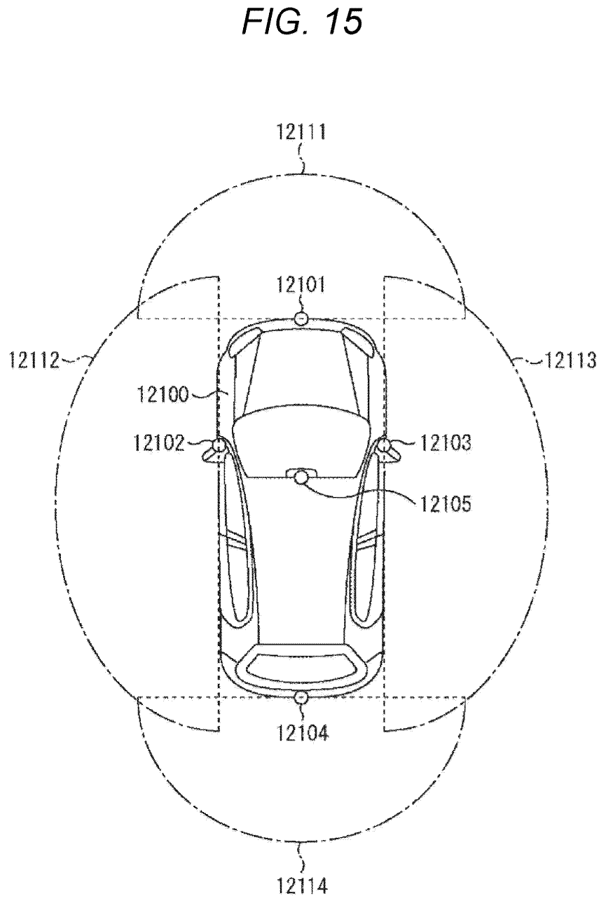

FIG. 15 is a diagram depicting an example of the installation position of the imaging section 12031.

In FIG. 15, the imaging section 12031 includes imaging sections 12101, 12102, 12103, 12104, and 12105.

The imaging sections 12101, 12102, 12103, 12104, and 12105 are provided, for example, at positions such as the front nose, the sideview mirrors, the rear bumper, the back door, and an upper portion of the windshield within the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 15 depicts one example of imaging ranges of the imaging sections 12101 to 12104. An imaging range 12111 represents the imaging range of the imaging section 12101 provided to the front nose, imaging ranges 12112 and 12113 respectively represent the imaging ranges of the imaging sections 12102 and 12103 provided to the sideview mirrors, and an imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information.

For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays.

The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to, for example, the imaging section 12031 among the configurations described above. Specifically, the arithmetic units according to the first to third embodiments can be applied to the imaging section 12031. By applying the technology according to the present disclosure, power consumption of the imaging section 12031 can be suppressed, so that power of the vehicle control system can be saved.

Note that the present technology may have the following configurations.
(1) An arithmetic unit including:
   a signal detector that outputs a first analog signal indicating a detection result of a physical signal;
   an AD converter provided at a subsequent stage of the signal detector; and
   a calculator that calculates a digital signal output from the AD converter and outputs a second analog signal indicating a calculation result, in which
   the signal detector includes a floating diffusion layer that converts the physical signal into the first analog signal, and
   the second analog signal is input to a preceding stage of the AD converter electrically connected to the floating diffusion layer.
(2) The arithmetic unit according to (1), further including a signal input selection unit that selects the first analog signal or the second analog signal as an input signal to the AD converter.
(3) The arithmetic unit according to any one of (1) to (3), further including
   a plurality of storage units that stores the digital signal between the AD converter and the calculator, and
   a signal storage selection unit that selects a storage destination of the digital signal from the plurality of storage units.
(4) The arithmetic unit according to any one of (1) to (4), further including a plurality of pixel arrays in which pixels including the signal detector and the AD converter are arranged in a two-dimensional array.
(5) The arithmetic unit according to (4), in which a shape of the pixel array is a positive direction.
(6) The arithmetic unit according to (4), in which the pixel array has a rectangular shape.
(7) The arithmetic unit according to any one of (1) to (6), in which a plurality of the signal detectors simultaneously detects the physical signal.
(8) The arithmetic unit according to any one of (4) to (6), in which an AD converter of a pixel provided in a pixel array as a detection target of the digital signal among the plurality of pixel arrays performs AD conversion on the first analog signal or the second analog signal.
(9) The arithmetic unit according to any one of (4) to (6), in which after AD converters of a plurality of pixel arrays output the digital signal, the digital signal of a specific pixel array is input to the calculator.
(10) The arithmetic unit according to any one of (1) to (9), in which the calculator includes a capacitive element for performing product-sum operation on the digital signal.
(11) The arithmetic unit according to (10), in which a weighting factor of the product-sum operation is set in the capacitive element on the basis of a power ratio of 2.
(12) The arithmetic unit according to (10), in which a weighting factor of the product-sum operation is set in the capacitive element on the basis of a logarithmic ratio.
(13) The arithmetic unit according to (10), in which a weighting factor of the product-sum operation is set in the capacitive element on the basis of a linear ratio.
(14) The arithmetic unit according to any one of (4) to (6), in which
   the second analog signal is input to AD converters of a plurality of pixel rows or a plurality of pixel columns, and
   a weighting factor used for calculation of the calculator is set for each of the AD converters of the plurality of pixel rows or the plurality of pixel columns.
(15) The arithmetic unit according to any one of (4) to (6), in which
   the AD converter performs AD conversion on the second analog signal by comparing the second analog signal with a reference signal, and
   the arithmetic unit further includes a signal processing circuit that generates a voltage distribution of the second analog signal when the second analog signal exceeds the reference signal.
(16) The arithmetic unit according to (15), in which a voltage range of the reference signal is optimized on the basis of the voltage distribution.
(17) The arithmetic unit according to any one of (4) to (6), further including
   a signal input/output unit that exchanges a pixel row and a pixel column of the digital signal or the second analog signal, in which
   the AD converter transposes and calculates the second analog signal.
(18) The arithmetic unit according to any one of (1) to (17), in which a weighting factor used when the AD converter performs AD conversion on the second analog signal is changed from a weighting factor used when the AD conversion is performed on the first analog signal.
(19) The arithmetic unit according to (17), in which the signal input/output unit includes metal wiring.
(20) The arithmetic unit according to (17), in which the signal input/output unit includes a flip-flop.
(21) The arithmetic unit according to (17), in which the signal input/output unit includes a tri-state inverter.
(22) The arithmetic unit according to any one of (1) to (21), further including
   a first substrate on which the signal detector is arranged, and
   a second substrate on which the calculator is arranged, in which
   the first substrate and the second substrate are laminated on top of each other.
(23) The arithmetic unit according to any one of (1) to (22), in which the physical signal includes an optical signal.
(24) The arithmetic unit according to any one of (1) to (23), in which circuit elements of the signal detector are dispersedly arranged on a plurality of Substrates.
(25) The arithmetic unit according to any one of claims 1 to 24, in which the calculator includes an analog neural network circuit.

### REFERENCE SIGNS LIST

1, 2, 2a, 2b Arithmetic unit
10 Pixel
11 Signal detector
12 Signal input selection unit
13 AD converter
14 Signal storage selection unit
15 Storage unit
20 Signal processing circuit
30 Calculator
40 Signal input/output unit
50 Signal input/output unit
101 First substrate
102 Second substrate
110 Pixel array
116 Floating diffusion layer
305 Capacitive element
411 Flip-flop
412 Tri-state inverter
413 Metal wiring

1. An arithmetic unit comprising:
a signal detector that outputs a first analog signal indicating a detection result of a physical signal;
an AD converter provided at a subsequent stage of the signal detector; and
a calculator that calculates a digital signal output from the AD converter and outputs a second analog signal indicating a calculation result, wherein
the signal detector includes a floating diffusion layer that converts the physical signal into the first analog signal, and
the second analog signal is input to a preceding stage of the AD converter electrically connected to the floating diffusion layer.

2. The arithmetic unit according to claim 1, further comprising a signal input selection unit that selects the first analog signal or the second analog signal as an input signal to the AD converter.

3. The arithmetic unit according to claim 1, further comprising
a plurality of storage units that stores the digital signal between the AD converter and the calculator, and
a signal storage selection unit that selects a storage destination of the digital signal from the plurality of storage units.

4. The arithmetic unit according to claim 1, further comprising a plurality of pixel arrays in which pixels including the signal detector and the AD converter are arranged in a two-dimensional array.

5. The arithmetic unit according to claim 4, wherein a shape of the pixel array is a positive direction.

6. The arithmetic unit according to claim 4, wherein the pixel array has a rectangular shape.

7. The arithmetic unit according to claim 1, wherein a plurality of the signal detectors simultaneously detects the physical signal.

8. The arithmetic unit according to claim 4, wherein an AD converter of a pixel provided in a pixel array as a detection target of the digital signal among the plurality of pixel arrays performs AD conversion on the first analog signal or the second analog signal.

9. The arithmetic unit according to claim 4, wherein after AD converters of a plurality of pixel arrays output the digital signal, the digital signal of a specific pixel array is input to the calculator.

10. The arithmetic unit according to claim 1, wherein the calculator includes a capacitive element for performing product-sum operation on the digital signal.

11. The arithmetic unit according to claim 10, wherein a weighting factor of the product-sum operation is set in the capacitive element on a basis of a power ratio of 2.

12. The arithmetic unit according to claim 10, wherein a weighting factor of the product-sum operation is set in the capacitive element on a basis of a logarithmic ratio.

13. The arithmetic unit according to claim 10, wherein a weighting factor of the product-sum operation is set in the capacitive element on a basis of a linear ratio.

14. The arithmetic unit according to claim 4, wherein
the second analog signal is input to AD converters of a plurality of pixel rows or a plurality of pixel columns, and
a weighting factor used for calculation of the calculator is set for each of the AD converters of the plurality of pixel rows or the plurality of pixel columns.

15. The arithmetic unit according to claim 4, wherein
the AD converter performs AD conversion on the second analog signal by comparing the second analog signal with a reference signal, and
the arithmetic unit further comprises a signal processing circuit that generates a voltage distribution of the second analog signal when the second analog signal exceeds the reference signal.

16. The arithmetic unit according to claim 15, wherein a voltage range of the reference signal is optimized on a basis of the voltage distribution.

17. The arithmetic unit according to claim 4, further comprising
a signal input/output unit that exchanges a pixel row and a pixel column of the digital signal or the second analog signal, wherein
the AD converter transposes and calculates the second analog signal.

18. The arithmetic unit according to claim 1, wherein a weighting factor used when the AD converter performs AD conversion on the second analog signal is changed from a weighting factor used when the AD conversion is performed on the first analog signal.

19. The arithmetic unit according to claim 17, wherein the signal input/output unit includes metal wiring.

20. The arithmetic unit according to claim 17, wherein the signal input/output unit includes a flip-flop.

21. The arithmetic unit according to claim 17, wherein the signal input/output unit includes a tri-state inverter.

22. The arithmetic unit according to claim 1, further comprising
a first substrate on which the signal detector is arranged, and
a second substrate on which the calculator is arranged, wherein
the first substrate and the second substrate are laminated on top of each other.

23. The arithmetic unit according to claim 1, wherein the physical signal includes an optical signal.

24. The arithmetic unit according to claim 1, wherein circuit elements of the signal detector are dispersedly arranged on a plurality of substrates.

25. The arithmetic unit according to claim 1, wherein the calculator includes an analog neural network circuit.
